(19) United States
(12) Patent Application Publication
(10) Pub. No.: US 2025/0150503 A1
(43) Pub. Date: May 8, 2025

(54) SERVICE-PROVIDER HOSTED CONTROL PLANE FOR A REMOTE DATA CENTER

(71) Applicant: INTERNATIONAL BUSINESS MACHINES CORPORATION, ARMONK, NY (US)

(72) Inventors: Joseph W. Cropper, Round Rock, TX (US); Julio Oliva, Austin, TX (US); Ping Chen, Austin, TX (US); Daniel Nhiem Nguyen, Cedar Park, TX (US); Corradino D. Jones, Austin, TX (US); Hariganesh Muralidharan, B. Narayanapura (IN); John B. Carter, Austin, TX (US); Shayma Venugopal, Hyderabad (IN); Paul Bernell Finley, JR., Austin, TX (US)

(21) Appl. No.: 18/501,289

(22) Filed: Nov. 3, 2023

(51) Int. Cl. H04L 67/10; G06F 9/50; H04L 67/51

(52) U.S. Cl. CPC H04L 67/10; G06F 9/5072; H04L 67/51

(57) ABSTRACT

Described are techniques for a control plane. The techniques include receiving, at the control plane hosted on a service-provider data center, a request to perform a computing resource operation at a remote data center, where the control plane is used to manage computing resources located at the remote data center. The techniques further include creating a data object at the service-provider data center to represent a status of the computing resource operation, and updating the data object in response to receiving indications of events associated with performance of the computing resource operation at the remote data center. The techniques further include receiving, at the control plane, a status request for the computing resource operation, querying the data object maintained at the service-provider data center for the status of the computing resource operation, and providing the status of the computing resource operation represented by the data object.

### BACKGROUND

The present disclosure relates to cloud computing, and, more specifically, to managing workloads in a cloud environment.

In the context of cloud computing, a control plane comprises a set of tools and services that manage and orchestrate workloads across multiple cloud environments that can include public and private clouds, and on-premises computing infrastructure(s). The control plane can include a configuration management component that is responsible for managing the configuration of cloud resources, a policy management component that is responsible for managing the policies that govern how cloud resources are used, and an orchestration component that is responsible for automating the deployment, scaling, and management of workloads across multiple cloud environments. The control plane provides a single point of control for managing the cloud resources, regardless of where the resources located, which simplifies operations and improves security and compliance.

### SUMMARY

Aspects of the present disclosure are directed toward a computer-implemented method comprising receiving, at a control plane hosted on a service-provider data center, an action request to perform a computing resource operation at a remote data center, wherein the control plane is used to manage computing resources located at the remote data center. The computer-implemented method further comprising creating a data object at the service-provider data center to represent a status of the computing resource operation. The computer-implemented method further comprising sending an instruction to a resource manager at the remote data center to initiate the computing resource operation, where, in response to an event associated with performance of the computing resource operation at the remote data center, the control plane receives an indication of the event and updates the data object located at the service-provider data center to represent the status of the computing resource operation indicated by the event. The computer-implemented method further comprising receiving, at the control plane, a status request for the computing resource operation. The computer-implemented method further comprising querying the data object maintained at the service-provider data center to obtain the status of the computing resource operation represented by the data object and providing the status of the computing resource operation represented by the data object maintained at the service-provider data center.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 is a block diagram illustrating an example computational environment implementing a service-provider hosted control plane for managing a status of a computing resource operation performed at a remote data center, in accordance with some embodiments of the present disclosure.

FIG. 2 is a sequence diagram that illustrates a sequence of processes performed in response to receiving an operation request at a service-provider hosted control plane, in accordance with some embodiments of the present disclosure.

FIG. 3 is a sequence diagram illustrating a sequence of processes performed in response to a determination that a status of a computing resource operation represented by a data object may be incorrect, in accordance with some embodiments of the present disclosure.

FIG. 4 is a flow diagram illustrating an example method for managing a status of a computing resource operation performed at a remote data center using a control plane hosted at a service-provider data center, in accordance with some embodiments of the present disclosure.

FIG. 5 is a block diagram that illustrates an example computing environment in which aspects of the present disclosure can be implemented, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward managing a status of a computing resource operation performed at a remote data center using a control plane hosted at a service-provider data center. While not limited to such applications, embodiments of the present disclosure may be better understood in light of the aforementioned context.

Hybrid cloud computing is a cloud computing model that combines a public cloud with on-premises or private cloud resources. This allows organizations to take advantage of the benefits of both cloud and on-premises computing, such as scalability, flexibility, and security. In one example scenario, a computing infrastructure (compute, network, and storage) owned by a service-provider can reside on-premises at a customer's data center. As such, the customer's application data does not leave the customer's data center. The computing infrastructure is managed via a control plane hosted on the service-provider's data center resources (public cloud). The customer interacts with the control plane to manage the on-premises environment (e.g., create virtual machines (VMs), storage volumes, virtual networks, etc.), which resides on-premises at the customer's data center, and which in some cases, can be hundreds or thousands of miles away from the service-provider's data center.

In cases where a customer's on-premises data center is located a long distance from a service provider's data center, communications between the customer's data center and the service-provider's data center can include high latency-unreliable network connections that can potentially affect operational performance of a cloud computing service. For example, long distance and high latency network connections can result in queueing of application programming interface (API) network traffic, particularly in remote locations that handle a high volume of network activity, such as a large enterprise that utilities a hybrid cloud model as the foundation of its corporate-wide private cloud, or a cloud-service provider that uses an edge cloud model to provide cloud services to its customers.

In the past, attempts to mitigate problems associated with high latency and/or unreliable network connections have included leveraging higher bandwidth, utilizing expensive network connections (e.g., point-to-point networks) and redundant network connections. However, these approaches are costly and do not fully address the inherent challenges associated with effectively managing a customer's remote data center at an enterprise service level.

Advantageously, aspects of the present disclosure address the challenges described above using a control plane that routes control plane read operations (e.g., status requests) to a local cache located at a service-provider's data center instead of making remote calls via a long distance—high-latency network connection to a customer's data center or an edge server(s). Routing the control plane read operations to the local cache reduces the amount of network traffic sent over the long distance—high-latency network connection, and reduces a load placed on a customer's data center resources and/or edge resources. Moreover, routing control plane read operations to the local cache improves request response times because long distance remote calls are not being made to the customer's data center over a high-latency network connection.

More specifically, in response to receiving a request at the control plane hosted at a service-provider data center, where the request is to perform a computing resource operation (e.g., provision, configure, or terminate a virtual machine (VM), storage volume, virtual network, etc.), aspects of the present disclosure create a data object stored locally at the service-provider data center to represent the status of the computing resource operation (e.g., “pending”, “running”, “terminated”, etc.) being performed at the remote data center. Also, as part of receiving the request, aspects of the present disclosure send an instruction to a resource manager at the remote data center to initiate the computing resource operation.

During performance of the computing resource operation at the remote data center, events associated with performance of the computing resource operation (e.g., creation events, loading events, modifying events, terminating events, etc.) are detected, and indications of the events are sent to the control plane at the service-provider data center. In response to receiving an indication of an event, aspects of the present disclosure update the data object located at the service-provider data center to represent the status of the computing resource operation as indicated by the event.

Any time after receiving the initial request, the control plane can receive status requests for the computing resource operation. In response to receiving a status request, aspects of the present disclosure query the data object maintained at the service-provider data center to obtain the status of the computing resource operation represented by the data object and provide the status to the requestor (e.g., a user or an application).

As another example advantage, aspects of the present disclosure can monitor the status of the computing resource operation via the data object located at the service-provider data center. In the case that monitoring the object determines that the status represented by the data object may be incorrect, aspects of the present disclosure can obtain a correct status of the computing resource operation directly from a resource manager located at the remote data center, and the data object located at the service-provider data center can be updated to represent the correct status of the computing resource operation.

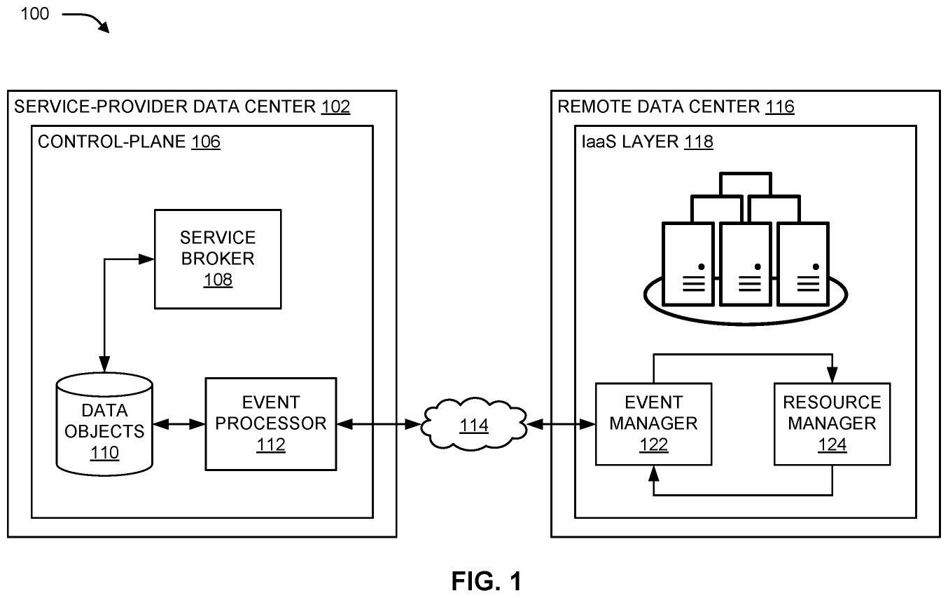

Referring now to the figures, FIG. 1 illustrates a block diagram of an example computational environment 100 that can implement a service-provider hosted control plane 106 used to manage a status of a computing resource operation that is being performed at a remote data center 116, in accordance with some embodiments of the present disclosure. As illustrated, the computational environment 100 comprises a service-provider data center 102 and a remote data center 116 that are in network communication via a network infrastructure 114.

The remote data center 116 hosts, on-premises, an Infrastructure-as-a-Service (IaaS) layer (e.g., compute, network, and storage) of a cloud computing model (e.g., a hybrid cloud model, edge cloud model, or the like). In some embodiments, the resources of the IaaS layer 118 (e.g., compute, network, and storage) can be service-provider owned resources that are installed on-premises of a customer's data center. In other embodiments, the resources of the IaaS layer 118 may be owned by a customer of a service-provider. Moreover, in some embodiments, the resources of the IaaS layer 118 can be edge computing resources located at a service-provider's remote data center. In some embodiments, the resources of the IaaS layer 118 may be owned by different organizational groups (e.g., subsidiaries of a multinational company located in different countries, different divisions of a company focused on different product lines and/or with different security requirements, etc.).

The service-provider data center 102 hosts a control plane 106 for managing resources of the IaaS layer 118 located at the remote data center 116. A user and/or cloud automation tool can interact with the control plane 106 to perform computing resource operations (e.g., create and manage VMs, storage volumes, virtual networks, etc.) and obtain information about the resources of the IaaS layer 118 (e.g., a status of a resource, specifications of a resource, etc.).

As illustrated, components of the control plane 106 can include a service broker 108, a data store for storing data objects 110, an event processor 112, and other components, as will be appreciated. The service broker 108 handles requests (e.g., action requests) to perform computing resource operations, as well as requests (e.g., status requests) for information related to the resources of the IaaS layer 118. The requests can comprise API requests, remote procedure requests, or other network commands used to communicate with the service broker 108. A user and/or a cloud automation tool sends requests to the service broker 108 to perform computing resource operations. In response to receiving such a request, the service broker 108 creates a data object 110 to represent the computing resource operation (or alternatively, to represent a computing resource associated with the computing resource operation), and the service broker 108 sends an instruction via the network infrastructure 114 to a resource manager 124 hosted at the remote data center 116 to perform the computing resource operation.

During performance of a computing resource operation, the event processor 112 receives from the event manager 122 indications of events associated with the computing resource operation and updates the data object 110 to represent a current status (or nearly current status) of the computing resource operation. A user and/or cloud automation tool can monitor performance of the computing resource operation by requesting that the service broker 108 provide the status of the computing resource operation. In response to such a request, instead of obtaining the status from the resource manager 124 hosted at the remote data center 116 (which would require sending a request via the network infrastructure 114, and thus contribute to, and be exposed to, high latency), the service broker 108 obtains the status of the computing resource operation from the data object 110 that represents the computing resource operation (or alternatively, represents a computing resource associated with the computing resource operation). As an illustration, the service broker 108 can receive a first API request to start a VM on the IaaS layer 118 hosted at the remote data center 116, and later receive a request for a status of the VM (e.g., “pending”, “running”, “stopped”, etc.). In response to the status request, the service broker 108 can retrieve the status of the VM from the local data object 110 that represents the VM, and the service broker 108 can respond to the API request with the status of the VM without having to obtain the status from the resource manager 124 located at the remote data center 116.

Also, during performance of the computing resource operation, the service broker 108 monitors the status of a computing resource operation by monitoring the data object 110 that represents the computing resource operation (or alternatively, represents a computing resource associated with the computing resource operation). By monitoring the data object 110, the service broker 108 can determine that the status represented by the data object 110 may be incorrect, and in response, obtain a correct status of the computing resource operation from the resource manager 124 located at the remote data center 116 by sending a status request to the resource manager 124. The service broker 108 can then update the data object 110 (or rebuild the data object 110) to represent the correct status of the computing resource operation.

In some embodiments, the service broker 108 determines that a status represented by a data object 110 may be incorrect by determining that a time to typically perform the computing resource operation has been exceeded. In one example, the time to typically perform the computing resource operation can be based on: the type of resource (e.g., VM, storage volume, virtual network, etc.) and/or the type of computing resource operation that is performed (e.g., provisioning, modifying, terminating, etc.) and/or a group of computing resource operations that are frequently issued together (e.g., provisioning several related VMs). In another example, the time to typically perform the computing resource operation can be based on aspects of the network infrastructure 114 (e.g., networking hardware, networking software, historical metrics, etc.) that connects the service-provider data center 102 to the remote data center 116. In yet another example, the time to typically perform the computing resource operation can be based on a predicted time to perform the computing resource operation. For example, a machine learning model (e.g., a neural network model) can be trained using historical performance data for the computing resource operation to generate the predicted time. As will be appreciated, any combination of the techniques above can be used to determine a time to typically perform a computing resource operation.

Components of the IaaS layer 118 hosted at the remote data center 116 can include the previously mentioned resource manager 124, an event manager 122, and other components, as will be appreciated. The resource manager 124 provides virtualization and cloud management of the IaaS layer 118. The service broker 108 interacts with the resource manager 124 to initiate a computing resource operation (e.g., provision, modify, terminate, etc. a computing resource) and, as needed, obtains a status of the computing resource operation when the service broker 108 determines that a status represented by a data object 110 may not be correct.

The event manager 122 detects cloud resource events (referred to herein as “events” or “event”) associated with a computing resource operation managed by the resource manager 124. An event comprises an action or occurrence associated with a computing resource operation (e.g., provisioning event, modifying event, terminating event, etc.) that can be recognized by the event manager 122 (e.g., via inspecting log files). For example, computing resource operations associated with provisioning, modifying, and terminating computing resources on the IaaS layer 118 generate (trigger) events. An event can indicate a status of a computing resource operation. For example, creating a VM can trigger events indicating that the VM is in the process of being provisioned (e.g., events related to allocation of VM resources, assignments of network addresses, etc.) and events indicating that the VM is up and running (e.g., events related to registering the VM as a resource on the IaaS layer 118). In response to detecting an event, the event manager 122 sends an indication of the event to the event processor 112 of the control plane 106 at the service-provider data center 102. The event processor 112, in response to receiving the indication of the event, identifies a data object 110 that represents a computing resource operation associated with the event, and the event processor 112 updates the data object 110 to a status indicated by the event.

FIG. 1 illustrates that the network infrastructure 114 is provided to enable communication between the components of the computational environment 100. The network infrastructure 114 can include any useful computing network, including an intranet, the Internet, a local area network, a wide area network, a wireless data network, or any other such network or combination thereof. Components utilized for the network infrastructure 114 can depend at least in part upon the type of network and/or environment selected. Communication over the network infrastructure 114 can be enabled by wired or wireless connections and combinations thereof. The term “data store” may refer to any device or combination of devices capable of storing, accessing, organizing and/or retrieving data, which may include any combination and number of data servers, relational databases, object oriented databases, cluster storage systems, data storage devices, data warehouses, flat files and data storage configuration in any centralized, distributed, or clustered environment. The storage system components of the data store may include storage systems such as a SAN (Storage Area Network), cloud storage network, volatile or non-volatile RAM, optical media, or hard-drive type media. The data store may be representative of a plurality of data stores as can be appreciated.

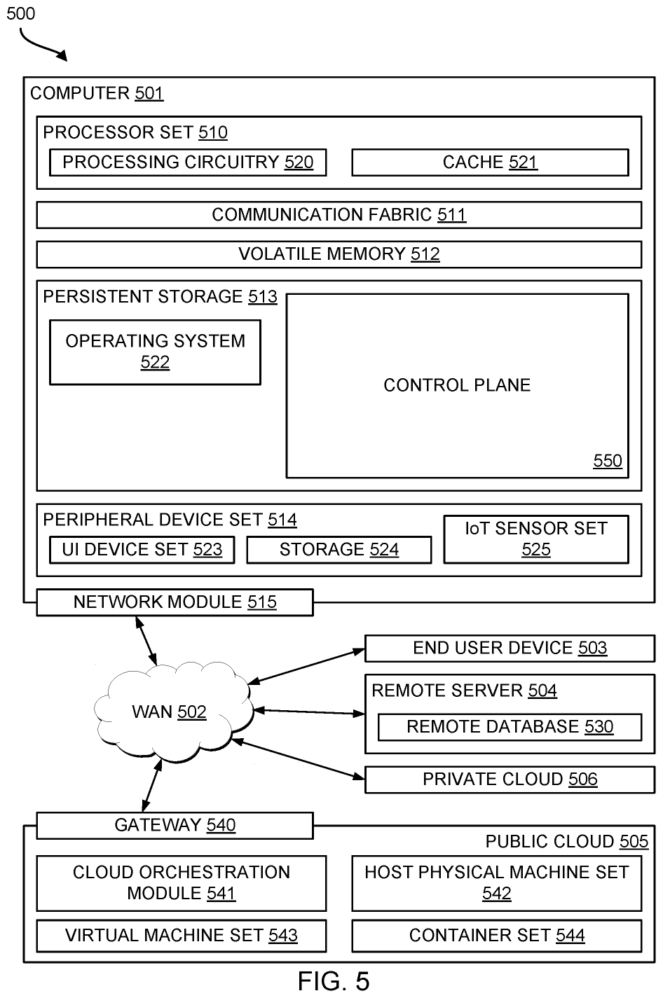

All or a portion of the computational environment 100 illustrated in FIG. 1, can be implemented by all or a subset of the computing environment 500 illustrated in FIG. 5. The components of the control plane 106 and/or the IaaS layer 118 can be implemented in software, hardware, firmware or a combination thereof. When firmware is used, the operations performed by the components can be implemented in program instructions and data and stored in persistent memory to run on a processor. When hardware is employed, the hardware can include circuits that operate to perform the operations of the components. When software is used, the operations performed by the components can be implemented in program instructions configured to run on hardware, such as a processor. For example, the components of the control plane 106 and/or the IaaS layer 118 can be implemented as modules. Generally, modules (also referred to as program modules) include routines, programs, components and/or data structures that perform particular tasks and/or implement particular abstract data types. In some embodiments, the modules can be implemented as computing services hosted in a computing service environment. For example, a module can be considered a service with one or more processes executing on a server or other computer hardware. Such services can provide a service application that receives requests and provides output to other services or consumer devices. An API can be provided for each module to enable a first module to send requests to and receive output from a second module. Such APIs can also allow third parties to interface with the module and make requests and receive output from the modules.

FIG. 1 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. That is, the example environment discussed and illustrated above is merely representative and is not meant to be limiting.

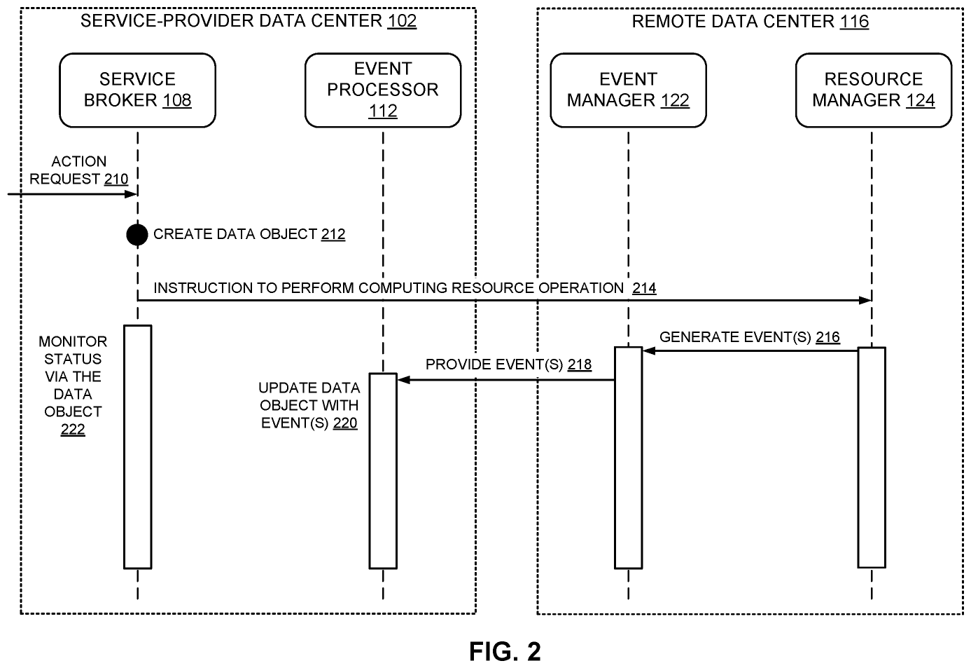

With continuing reference to FIG. 1, FIG. 2 illustrates a sequence of processes performed in response to the service broker 108 receiving an action request 210. The action request 210 instructs the service broker 108 to initiate a computing resource operation, such as, but not limited to, provisioning, modifying, or terminating a VM, storage volume, virtual network, and the like. The action request 210 can be from a user or a cloud automation tool.

In response to receiving the action request 210, the service broker 108 creates 212 a data object 110 to represent a status of the computing resource operation. The data object 110 comprises a region of storage in the service-provider data center 102 that contains a value or group of values (e.g., resource identifier, data center identifier, status, etc.) representing the computing resource operation. The values can be accessed using the data object's identifier or a more complex expression that refers to the data object 110. After creating the data object 110, the service broker 108 sets a status value of the data object 110 to indicate that the computing resource operation is being performed (e.g., “pending”). Also, as part of receiving the action request 210, the service broker 108 programmatically sends an instruction 214 to the resource manager 124 to perform the computing resource operation.

Events generated 216 during performance of the computing resource operation are detected by the event manager 122. In response to detecting the events, the event manager 122 programmatically provides/communicates 218 indications of the detected events to the event processor 112. Illustratively, providing 218 an indication of an event can comprise sending a message by the event manager 122 to the event processor 112. The message can include information related to the event, such as, a cloud resource identifier, details of the operation or action performed, results of the operation or action, and other information as will be appreciated. As an illustration, information in an event message associated with resizing a VM may include “VM-1 successfully resized vCPU from 1->2 vCPUS”, and information in an event message associated with modifying a VM's storage volume may include “Volume-1 successfully detached from VM-2”.

In response to receiving an indication of an event associated with the computing resource operation, the event processor 112 updates 220 the data object 110 to a status indicated by the event (e.g., update from “pending” to “running”). During performance of the computing resource operation, a user and/or a cloud automation tool can request that the service broker 108 provide status information associated with the computing resource action. In response, the service broker 108 queries the data object 110 for a status and returns the status to the user and/or cloud automation tool.

To provide a correct status of the computing resource operation, the service broker 108 monitors 222 the data object 110 during performance of the computing resource operation to proactively detect an error that causes the data object 110 to represent an incorrect status of the computing resource operation. Illustratively, a status represented by a data object 110 may be incorrect when one or more messages indicating one or more events sent by the event manager 122 are not received by the event processor 112 due to high-latency or failures in the network infrastructure 114. Because the service broker 108 may be unaware of issues affecting transmission of messages from the remote data center 116 over the network infrastructure 114, the service broker 108 relies on heuristics to determine that a status of a computing resource operation represented by the data object 110 may no longer be current. For example, an event indicating that a computing resource operation has completed can be detected by the event manager 122 located at the remote data center 116, and the event manager 122 can send a message indicating completion of the computing resource operation to the event processor 112 located at the service-provider data center 102. However, due to high-latency or failures in the network infrastructure 114, the message may not be received, or may not be received in time, by the event processor 112 to allow the data object 110 to be updated to a status that correctly represents the computing resource operation. As such, the service broker 108 monitors 222 the status represented by the data object 110, and if the status is not an expected value that is based on a heuristic, the service broker 108 can request a current status of the computing resource operation from the resource manager 124 located at the remote data center 116, as described below.

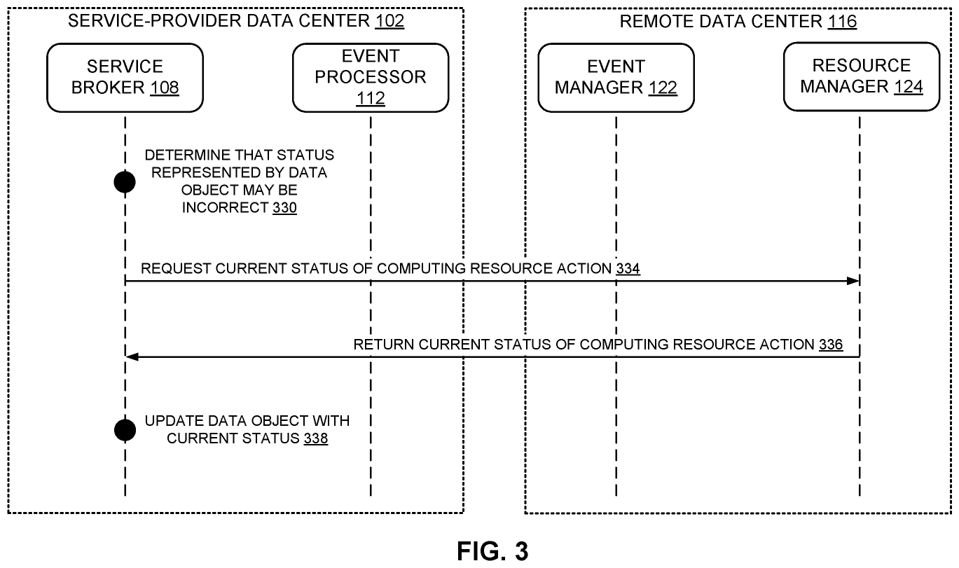

With continuing reference to FIG. 1, FIG. 3 illustrates a sequence of processes performed in response to a determination 330 that a status of a computing resource operation represented by a data object 110 may be incorrect. As described above, the service broker 108 monitors a status of a computing resource operation by monitoring a data object 110 that represents the computing resource operation. In some embodiments, the service broker 108 determines 330 that the status represented by the data object 110 may be incorrect by monitoring an amount of time between updates of the data object 110. If the amount of time between updates exceeds a time to typically perform a computing resource operation (or an aspect of the computing resource operation), the service broker 108 determines that the status represented by the data object 110 may be incorrect, and the service broker 108 sends a request for a current status of the computing resource operation to the resource manager 124 at the remote data center 116.

In some embodiments, a time to typically perform a computing resource operation can be a total amount of time to complete the computing resource operation (e.g., an amount of time between receiving the request at the service broker 108 to perform the computing resource operation to receiving at the service broker 108 an indication that the computing resource operation has completed). Alternatively, the service broker 108 can monitor a time to typically perform various aspects of the computing resource operation (e.g., allocation of resources, loading resource, starting resource, migrating resource, etc.).

The time to typically perform the computing resource operation (or an individual aspect of the computing resource operation) can be based on one or more factors that include, but are not limited to, the type of the computing resource (e.g., VM, storage volume, virtual network, etc.), the type of operation being performed (e.g., provisioning, modifying, terminating, etc.), aspects of the network infrastructure 114 (e.g., networking hardware and software, distance of remote data center 116 to service-provider data center 102, historical transmission rates, historical error rates, etc.) that affect transmission reliability of the network infrastructure 114, and the like. Historical data associated with a computing resource operation can be utilized to determine a typical time for performing the computing resource operation (or individual aspects of the computing resource operation). For example, historical data for provisioning or modifying a computing resource can be used to determine an average, median, or mode time for provisioning or modifying the computing resource, and/or performing the aspects of provisioning or modifying the computing resource. As an illustration, historical data for provisioning a VM can be used to determine an average time (standard deviation of time) to provision the VM, as well as determine average times for performing aspects of provisioning the VM (e.g., allocation of resources, loading VM image, starting VM, etc.). A status of a computing resource operation, in some embodiments, may be viewed as possibly incorrect if a message is not received from the event manager 122 within a predetermined number of standard deviations of a historical average time for performing the computing resource operation or performing an aspect of the computing resource operation.

Moreover, the time to typically perform the computing resource operation (or individual aspects of the computing resource operation) can be based on a predicted time generated by a machine learning model that is trained to generate predicted times for the computing resource operation using historical data and various features associated with the computing resource operation. The features used to train the machine learning model can include, but are not limited to, computing resource features (e.g., VM, storage volume, virtual network, etc.), computing resource operation features (e.g., provisioning, modifying, terminating, etc.), features of the network infrastructure 114 (e.g., networking hardware and software, distance of remote data center 116 to service-provider data center 102, historical transmission rates, historical error rates, etc.), and other features as will be appreciated. Based on inputting features of a computing resource operation to the trained machine learning model, the trained model predicts a time to typically perform the computing resource operation.

In response to determining 330 that the status represented by the data object 110 may be incorrect, the service broker 108 requests 334 the current status of the computing resource operation from the resource manager 124 located at the remote data center 116. Because the resource manager 124 actively manages performance of the computing resource operation at the remote data center 116, the resource manager 124 has access to status information (e.g., log files) for the computing resource operation. In response to the request from the service broker 108, the resource manager 124 obtains the current status of the computing resource operation and returns 336 the current status to the service broker 108. The service broker 108 then updates 338 the data object 110 with the current status of the computing resource operation (or alternatively reconstructs the data object 110 using the current status information received from the resource manager 124. Thereafter, in response to status requests received from a user and/or cloud automation tool, the service broker 108 queries the data object 110 for the status and returns the status to the user and/or cloud automation tool instead of making a remote call to the resource manager 124 via the network infrastructure 114 (which may comprise a long distance-high-latency network connection). In the illustrative examples above, the use of the same reference numeral in more than one figure represents the same element in the different figures.

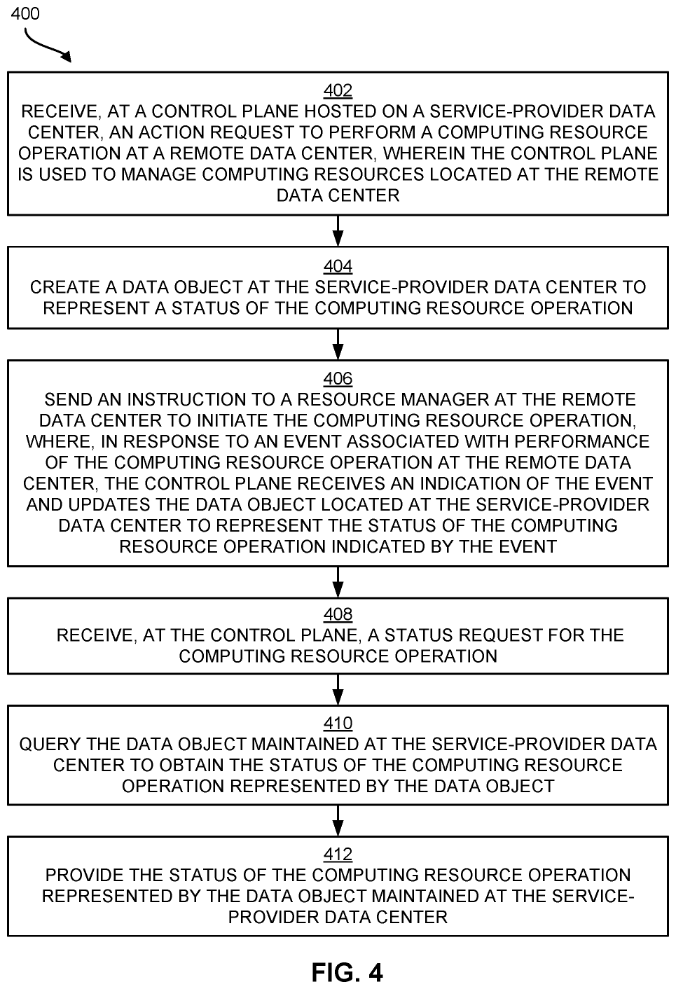

Moving now to FIG. 4, illustrated is a flow diagram of an example method 400 for managing a status of a computing resource operation performed at a remote data center using a control plane hosted at a service-provider data center, in accordance with some embodiments of the present disclosure. As described elsewhere herein, the control plane routes control plane read operations (e.g., status requests) to a local cache located at a service-provider's data center instead of making remote calls via a long distance-high-latency network connection to a remote data center. Routing the control plane read operations to the local cache reduces the amount of network traffic sent over the long distance-high-latency network connection, and reduces a load placed on the resources at the remote data center.

Accordingly, in operation 402, the method 400 receives at the control plane hosted at a service-provider data center, an action request to perform a computing resource operation at the remote data center. The control plane is used to manage computing resources located at the remote data center. In some embodiments, the computing resources in the remote data center provide an IaaS layer of a hybrid cloud infrastructure, and the control plane located at the service-provider data center is used to manage the computing resources providing the IaaS layer of the hybrid cloud infrastructure. As an example, a computing infrastructure (compute, network, and storage) owned by a service-provider can reside on-premises at a customer's remote data center, where the computing infrastructure is managed via the control plane hosted on the service-provider's data center resources. The customer interacts with the control plane to manage the on-premises environment (e.g., to create VMs, storage volumes, virtual networks, and the like) which resides on-premises at the customer's remote data center.

In some embodiments, the computing resources in the remote data center provide an IaaS layer of an edge computing infrastructure, and the control plane located at the service-provider data center is used to manage the computing resources providing the IaaS layer of the edge computing infrastructure. For example, the control plane hosted at the service-provider data center can be used to manage edge computing resources located at a remote data center, which may be hundreds or even thousands of miles away from the service-provider data center.

In operation 404, the method 400 creates a data object at the service-provider data center to represent a status of the computing resource operation. Also, in operation 406, the method 400 sends an instruction to a resource manager at the remote data center to initiate the computing resource operation, where, in response to an event associated with performance of the computing resource operation at the remote data center, the control plane receives an indication of the event and updates the data object located at the service-provider data center to represent the status of the computing resource operation indicated by the event.

While the computing resource operation is being performed at the remote data center, the control plane monitors the status of the computing resource operation by way of the data object located at the service-provider data center. As part of monitoring the status represented by the data object, the control plane may determine that the status represented by the data object may be incorrect. In some embodiments, determining that the status may be incorrect comprises determining, by the control plane, that a time to typically perform the computing resource operation has been exceeded. In some embodiments, the time to typically perform the computing resource operation can be based, at least in part, on a type of the computing resource operation, a network infrastructure that connects the service-provider data center to the remote data center, and/or a predicted time to perform the computing resource operation generated by a machine learning model trained to generate the predicted time. In response to a determination by the control plane that the status represented by the data object may be incorrect, the control plane obtains a correct status of the computing resource operation from a resource manager located at the remote data center and updates the data object to represent the correct status of the computing resource operation.

In operation 408, the method 400 receives, at the control plane, a status request for the computing resource operation being performed at the remote data center. Illustratively, the status request can be from a user or cloud automation tool asking for a current status (e.g., pending, running, failed, etc.) of the computing resource operation.

In operation 410, in response to the status request, the method 400 queries the data object maintained at the service-provider data center to obtain the status of the computing resource operation represented by the data object. By obtaining the status from the data object, the control plane avoids making a remote call to a resource manager located at the remote data center via the network infrastructure which may comprise a long distance-high-latency network connection.

In operation 412, the method 400 then provides the status of the computing resource operation represented by the data object maintained at the service-provider data center to the requestor (e.g., user or cloud automation tool). The method described above in association with FIG. 4 can be performed by a computer (e.g., computer 501 in FIG. 5), performed in a cloud environment (e.g., clouds 506 or 505 in FIG. 5), and/or generally can be implemented in fixed-functionality hardware, configurable logic, logic instructions, etc., or any combination thereof.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code involved in performing the disclosed methods, such as a service-provider hosted control plane for a remote data center in block 550. In addition to block 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 521 and the other storage media discussed below. The computer readable program instructions, and associated data, are accessed by processor set 510 to control and direct performance of the disclosed methods. In computing environment 500, at least some of the instructions for performing the disclosed methods may be stored in block 550 in persistent storage 513.

COMMUNICATION FABRIC 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid-state storage devices. Operating system 522 may take several forms, such as various known proprietary operating systems or open-source Portable Operating System Interface type operating systems that employ a kernel. The code included in block 550 typically includes at least some of the computer code involved in performing the disclosed methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the disclosed methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. The terms “comprises,” “comprising,” “includes,” “including,” “has,” “having,” “contains” or “containing,” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. It is also to be understood that the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Any data and data structures illustrated or described herein are examples only. In addition, any data can be combined with logic, so that a separate data structure may not be necessary.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure. Note further that numerous aspects or features are disclosed herein, and unless inconsistent, each disclosed aspect or feature is combinable with any other disclosed aspect or feature as desired for a particular application of the concepts disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Furthermore, as used herein, the terms “example” and/or “illustratively” are utilized to mean serving as an example, instance, or illustration. For the avoidance of doubt, the subject matter described herein is not limited by such examples. In addition, any aspect or design described herein as an “example” and/or an “illustration” is not necessarily to be construed as preferred or advantageous over other aspects or designs, nor is it meant to preclude equivalent exemplary structures and techniques known to those of ordinary skill in the art. Any advantages discussed in the present disclosure are example advantages, and embodiments of the present disclosure can exist that realize all, some, or none of any of the discussed advantages while remaining within the spirit and scope of the present disclosure.

What is claimed is:

1. A computer-implemented method comprising:
receiving, at a control plane hosted on a service-provider data center, an action request to perform a computing resource operation at a remote data center, wherein the control plane is used to manage computing resources located at the remote data center;
creating a data object at the service-provider data center to represent a status of the computing resource operation at the remote data center;
sending an instruction, to a resource manager at the remote data center, to initiate the computing resource operation,
wherein, in response to an event associated with performance of the computing resource operation at the remote data center, the control plane receives an indication of the event and updates the data object located at the service-provider data center to represent the status of the computing resource operation indicated by the event;
receiving, at the control plane, a status request for the computing resource operation;
querying the data object maintained at the service-provider data center to obtain the status of the computing resource operation represented by the data object; and
providing the status of the computing resource operation represented by the data object maintained at the service-provider data center.

2. The computer-implemented method of claim 1, further comprising:
monitoring the status of the computing resource operation by way of the data object located at the service-provider data center;
determining that the status represented by the data object may be incorrect;
obtaining a correct status of the computing resource operation from a resource manager located at the remote data center; and
updating the data object to represent the correct status of the computing resource operation.

3. The computer-implemented method of claim 2, wherein determining that the status represented by the data object may be incorrect comprises:
determining that a time to typically perform the computing resource operation has been exceeded.

4. The computer-implemented method of claim 3, further comprising:
identifying the time to typically perform the computing resource operation based at least in part on a type of the computing resource operation.

5. The computer-implemented method of claim 3, further comprising:
identifying the time to typically perform the computing resource operation based at least in part on a network infrastructure that connects the service-provider data center to the remote data center.

6. The computer-implemented method of claim 3, further comprising:
identifying the time to typically perform the computing resource operation based at least in part on a predicted time to perform the computing resource operation, wherein a machine learning model is trained to generate the predicted time.

7. The computer-implemented method of claim 1, wherein computing resources in the remote data center provide an Infrastructure-as-a-Service (IaaS) layer of a hybrid cloud infrastructure, and the control plane located at the service-provider data center is used to manage the computing resources providing the IaaS layer of the hybrid cloud infrastructure.

8. The computer-implemented method of claim 1, wherein computing resources in the remote data center provide an IaaS layer of an edge computing infrastructure, and the control plane located at the service-provider data center is used to manage the computing resources providing the IaaS layer of the edge computing infrastructure.

9. A system comprising:
one or more computer readable storage media storing program instructions and one or more processors which, in response to executing the program instructions, are configured to:
receive, at a control plane hosted on a service-provider data center, an action request to perform a computing resource operation at a remote data center, wherein the control plane is used to manage computing resources located at the remote data center;
create a data object at the service-provider data center to represent a status of the computing resource operation at the remote data center;
send an instruction, to a resource manager at the remote data center, to initiate the computing resource operation,
wherein, in response to an event associated with performance of the computing resource operation at the remote data center, the control plane receives an indication of the event and updates the data object located at the service-provider data center to represent the status of the computing resource operation indicated by the event;
receive, at the control plane, a status request for the computing resource operation;
query the data object maintained at the service-provider data center to obtain the status of the computing resource operation represented by the data object; and
provide the status of the computing resource operation represented by the data object maintained at the service-provider data center.

10. The system of claim 9, wherein the program instructions are further configured to cause the one or more processors to:
monitor the status of the computing resource operation by way of the data object located at the service-provider data center;
determine that the status represented by the data object may be incorrect;
obtain a correct status of the computing resource operation from a resource manager located at the remote data center; and
update the data object to represent the correct status of the computing resource operation.

11. The system of claim 10, wherein the program instructions configured to cause the one or more processors to determine that the status represented by the data object may be incorrect are further configured to cause the one or more processors to:
determine that a time to typically perform the computing resource operation has been exceeded.

12. The system of claim 11, wherein the program instructions are further configured to cause the one or more processors to:
identify the time to typically perform the computing resource operation based at least in part on a type of the computing resource operation.

13. The system of claim 11, wherein the program instructions are further configured to cause the one or more processors to:
identify the time to typically perform the computing resource operation based at least in part on a network infrastructure that connects the service-provider data center to the remote data center.

14. The system of claim 11, wherein the program instructions are further configured to cause the one or more processors to:
identify the time to typically perform the computing resource operation based at least in part on a predicted time to perform the computing resource operation, wherein a machine learning model is trained to generate the predicted time.

15. A computer program product comprising:
one or more computer readable storage media, and program instructions collectively stored on the one or more computer readable storage media, the program instructions configured to cause one or more processors to:
receive, at a control plane hosted on a service-provider data center, an action request to perform a computing resource operation at a remote data center, wherein the control plane is used to manage computing resources located at the remote data center;
create a data object at the service-provider data center to represent a status of the computing resource operation at the remote data center;
send an instruction, to a resource manager at the remote data center, to initiate the computing resource operation,
wherein, in response to an event associated with performance of the computing resource operation at the remote data center, the control plane receives an indication of the event and updates the data object located at the service-provider data center to represent the status of the computing resource operation indicated by the event;
receive, at the control plane, a status request for the computing resource operation;
query the data object maintained at the service-provider data center to obtain the status of the computing resource operation represented by the data object; and
provide the status of the computing resource operation represented by the data object maintained at the service-provider data center.

16. The computer program product of claim 15, wherein the program instructions are further configured to cause the one or more processors to:
monitor the status of the computing resource operation by way of the data object located at the service-provider data center;
determine that the status represented by the data object may be incorrect;
obtain a correct status of the computing resource operation from a resource manager located at the remote data center; and
update the data object to represent the correct status of the computing resource operation.

17. The computer program product of claim 16, wherein the program instructions configured to cause the one or more processors to determine that the status represented by the data object may be incorrect are further configured to cause the one or more processors to:
determine that a time to typically perform the computing resource operation has been exceeded.

18. The computer program product of claim 17, wherein the program instructions are further configured to cause the one or more processors to:
identify the time to typically perform the computing resource operation based at least in part on a type of the computing resource operation.

19. The computer program product of claim 17, wherein the program instructions are further configured to cause the one or more processors to:
identify the time to typically perform the computing resource operation based at least in part on a network infrastructure that connects the service-provider data center to the remote data center.

20. The computer program product of claim 17, wherein the program instructions are further configured to cause the one or more processors to:
identify the time to typically perform the computing resource operation based at least in part on a predicted time to perform the computing resource operation, wherein a machine learning model is trained to generate the predicted time.
